(19) United States
(12) Patent Application Publication
(10) Pub. No.: US 2023/0376614 A1
(43) Pub. Date: Nov. 23, 2023

(54) METHOD FOR DECODING AND ENCODING NETWORK STEGANOGRAPHY UTILIZING ENHANCED ATTENTION MECHANISM AND LOSS FUNCTION

(71) Applicant: Wuhan University, Wuhan (CN)

(72) Inventors: Zhaocong WU, Wuhan (CN); Keyi RAO, Wuhan (CN); Zhao YAN, Wuhan (CN)

(21) Appl. No.: 18/199,388

(22) Filed: May 19, 2023

(30) Foreign Application Priority Data
May 19, 2022 (CN) 202210543341.8

(51) Int. Cl. G06F 21/60; G06N 3/08

(52) U.S. Cl. CPC G06F 21/602; G06N 3/08

(57) ABSTRACT

A method for decoding and encoding network steganography includes: extracting an attention mask of a container image by a convolutional block attention network; extracting two-dimensional image features of a secret image by a feature preprocessing network; splicing the two-dimensional image features and the attention mask of the container image and the secret image in a channel layer, and inputting a spliced image into an encoding network to generate a stego image; inputting the stego image and the container image into a decoding network to respectively obtain a reconstructed secret image and a generated secret image; and constructing a total loss function considering a similarity between the container image and the stego image, a similarity between the secret image and the reconstructed secret image, and a difference between the reconstructed secret image and the generated secret image, and thus performing training on a network model.

### CROSS-REFERENCE TO RELATED APPLICATIONS

Pursuant to 35 U.S.C. § 119 and the Paris Convention Treaty, this application claims foreign priority to Chinese Patent Application No. 202210543341.8 filed May 19, 2022, the contents of which, including any intervening amendments thereto, are incorporated herein by reference. Inquiries from the public to applicants or assignees concerning this document or the related applications should be directed to: Matthias Scholl P C., Attn.: Dr. Matthias Scholl Esq., 245 First Street, 18th Floor, Cambridge, MA 02142.

### BACKGROUND

The disclosure relates to the field of computer vision and image processing technologies, and in particular to a method for decoding and encoding network steganography utilizing an enhanced attention mechanism and loss function.

In the information era, it is necessary for individuals or states to transmit and receive confidential information securely in the internet. In the field of information security, there are two major researches, i.e. cryptography and steganography. The cryptography is to protect information based on unintelligibility of cipher texts such that only the senders and receivers are allowed to view the transmitted contents. Thus, the information can be encoded to achieve information hiding. But, the unintelligibility of the cryptography also exposes the information importance. In contrast, the steganography is to protect information based on imperceptibility of cipher texts, namely, embeds secret information into a multimedia carrier such as a digital image while the visual and statistical characteristics of the carrier are kept unchanged as possible, so as to cover the purpose of “performing covert communication”. Compared with the cryptography, it is more prudent to transmit confidential information in steganography such that the attackers do not know the presence of the confidential information in the transmission process. As a result, anyone other than the target receivers is prevented from knowing the event of transmission of the confidential information. Further, the steganography can also be understood as a process of hiding secret multimedia data into other multimedia.

The multimedia data widely transmitted in the internet provides rich secret carriers for information hiding. At present, based on the formats of secret information and carriers, for example, text, image, audio, video, and protocol and the like, the steganography can be divided into several types. The image-hiding-image steganography is to embed a secret image into a digital image serving as a container to disguise the digital image to be a stego image the same as an original container image, so as to achieve covert transmission of the information. There are three major indexes for measuring the performance of the image steganography: steganography capacity, imperceptibility and robustness. The steganography capacity refers to a size of secret information that can be embedded into the carrier container. The imperceptibility refers to no difference between the generated stego image and the container image, which are made similar to each other in visual and statistical characteristics as possible to disable a steganalysis detection model to distinguish them. The robustuness refers to an anti-steganalysis capability in a transmission process. The three indexes are in conflict and cannot reach the optimum at the same time. In specific applications, it is necessary to seek a particular balance among them. For hiding of image information, efforts should be made to seek high imperceptibility and large steganography capacity while sacrificing the robustness to some degree. Further, reversely, the image-hiding-image steganography means a secret image can be recovered from a steganography image, where the extracted image is called reconstructed image. The reconstructed image should also be made similar to the secret image as possible in visual and statistical characteristics, so as to avoid information loss.

The traditional steganography technology is basically based on least significant bit (LSB) technology. Along with fast development of deep learning, the steganography gradually starts to be correlated with deep learning algorithms. A convolutional neural network, as a model in the deep learning algorithms, performs excellently in automatic feature extraction of large-scale data. The image-hiding-image steganography based on convolutional neural network can automatically update network parameters and extract image features, which not only extends the secret carriers and the secret information embedding amount to embed an entire secret image into a container, for example, based on image-hiding-image steganography and video-hiding-image steganography and the like, but also greatly improves the similarity between the container medium and the secret-containing medium, and achieves the imperceptibility of the image steganography.

A deep steganography model with an encoding and decoding network as architecture can apply the deep learning to the steganography. But, there are still the following problems. Firstly, because the loss function is only a mean square error loss function for computing distance pixel by pixel, the generated image has brightness, contrast and resolution entirely different from the original image. Secondly, the secret information in the reconstructed secret image is interfered with by the information of the container image. Thirdly, the position of hiding the secret is not selected based on the characteristics of the container image, leading to a lethal problem of the steganography: the secret information is basically uniformly embedded into the corresponding positions of the channels of the container image; once a secret stealer obtains the original container image, the secret stealer can obtain a rough morphology and basic information of the secret image by computing a residual value of the stego image and the container image.

### SUMMARY

For the problems in the prior arts, the disclosure provides a method for decoding and encoding network steganography utilizing an enhanced attention mechanism and loss function.

In order to address the above technical problems, the disclosure provides the following technical solution: a method for decoding and encoding network steganography utilizing an enhanced attention mechanism and loss function is provided, which includes the following steps:
S1, extracting an attention mask of a container image by a convolutional block attention network; extracting two-dimensional image features of a secret image by a feature preprocessing network;
at S2, splicing the two-dimensional image features and the attention mask of the container image and the secret image in a channel layer, and inputting a spliced image into an encoding network to generate a stego image;
S3, inputting the stego image and the container image into a decoding network to respectively obtain a reconstructed secret image and a generated secret image;
S4, by using a composite function based on a mean square error of pixel values and an image multi-scale structural similarity, constructing a total loss function considering a similarity between the container image and the stego image, a similarity between the secret image and the reconstructed secret image, and a difference between the reconstructed secret image and the generated secret image, and thus performing training on a network model.

Furthermore, the disclosure provides a method for decoding and encoding network steganography utilizing an enhanced attention mechanism and loss function, the implementation of S1 comprises the following steps:
S1.1, inputting the container image into the convolutional block attention network to generate the attention mask such that the encoding network reasonably selects a range and a position of embedding a secret into the container image;
S1.2, inputting the secret image into the feature preprocessing network to obtain the two-dimensional image features of the secret image.

Furthermore, the disclosure provides a method for decoding and encoding network steganography utilizing an enhanced attention mechanism and loss function, the convolutional block attention network uses ResNet50 as a benchmark architecture comprising a channel attention module and a spatial attention module to respectively perform attention mask extraction in channel and space, wherein the channel attention module and the spatial attention module are combined in a sequence of channel before space.

Furthermore, the disclosure provides a method for decoding and encoding network steganography utilizing an enhanced attention mechanism and loss function, the implementation of S3 comprises the following steps:

S3.1, inputting the stego image generated in S2 into the decoding network to obtain the reconstructed secret image and determining a similarity between the reconstructed secret image and an original secret image;

S3.2, inputting the container image to the decoding network to obtain the generated secret image and computing a difference between the generated secret image and the reconstructed secret image.

Furthermore, the disclosure provides a method for decoding and encoding network steganography utilizing an enhanced attention mechanism and loss function, the implementation of S4 comprises the following steps:

S4.1, computing the composite function based on the mean square error of pixel values and the image multi-scale structural similarity:

L^{Mix}(x−x′)=α·L^{MS-SSIM}(x−x′)+(1−α)·G_{σ}_{_{G}}_{^{M}}·L^{l}^{₂}(x−x′)
wherein, L^{MS-SSIM} represents a multi-scale structural similarity loss function, which considers brightness, contrast, structure and resolution, and is very sensitive to partial structural change and retains high-frequency details; L^{l}^{₂} represents a mean square error loss function to compute a Euclidean distance between a true value and a prediction value pixel by pixel, α refers to a balance parameter for a proportion of multi-scale structural similarity loss and a mean square error loss in the composite function; and G_{σ}_{_{G}}_{^{M}} refers to a Gaussian distribution parameter;
S4.2, constructing the total loss function considering the similarity between the container image and the stego image, the similarity between the secret image and the reconstructed secret image, and a difference between the reconstructed secret image and the generated secret image:

$${L}_{total} = {λ}_{c} {L}^{M i x} ( C - {C}^{′} ) + {λ}_{s} {L}^{M i x} ( S - {S}^{′} ) + {λ}_{r} \frac{1}{{L}^{M i x} ( {S}^{′} - G )}$$

wherein, Lₜₒₜₐₗ represents a steganography loss function, L^{Mix}(C−C′) represents an error item of the container image C and the stego image C′; L^{Mix}(S−S′) represents an error term of the secret image S and the reconstructed secret image 5′; L^{Mix} (S′−G) represents an error of the reconstructed secret image S′ and the generated secret image G, and λc, λs, λr respectively represent balance parameters for proportions of the error item of the container image and the stego image, the error term of the secret image and the reconstructed secret image, and the error of the reconstructed secret image and the generated secret image in the steganography loss function.

Compared with the prior arts, the disclosure has the following beneficial effects.
1. The disclosure makes improvements. Under the framework of the encoding and decoding networks, a convolutional block attention model is introduced to obtain space and channel attention masks of the container image, such that the network can clearly learn an attention center and an inconspicuous region of the container image so as to update the position of embedding secret into container. In this way, the secret stealer is prevented from obtaining the secret image by computing the residual value of the stego image and the container image. Thus, the security and robustness of the stego image can be improved, and the secret embedding region can be better determined.
2. In the disclosure, one composite function is used to direct image training to improve the similarities between the stego image and the container image and between the secret image and the reconstructed secret image in brightness, contrast and resolution, thereby improving the imperceptibility of the stego image.
3. In the disclosure, the difference between the reconstructed secret image and the generated secret image is introduced to the loss value to improve the entire similarities between the stego image and the container image and between the secret image and the reconstructed secret image. Further, the influence of the container image information on the reconstructed secret image can be avoided as possible, the loss of information in the reconstructed secret image is reduced, and the similarity between the reconstructed secret image and the original secret image is improved.

### BRIEF DESCRIPTIONS OF THE DRAWINGS

FIG. 1 is a flowchart illustrating a method for decoding and encoding network steganography utilizing an enhanced attention mechanism and loss function according to an embodiment of the disclosure.

FIG. 2 is a flowchart illustrating a network forward computation according to an embodiment of the disclosure.

FIG. 3 is a schematic diagram illustrating a sample result of image steganography and reconstruction according to an embodiment of the disclosure.

FIG. 4 is a schematic diagram illustrating a training process of image steganography and reconstruction according to an embodiment of the disclosure.

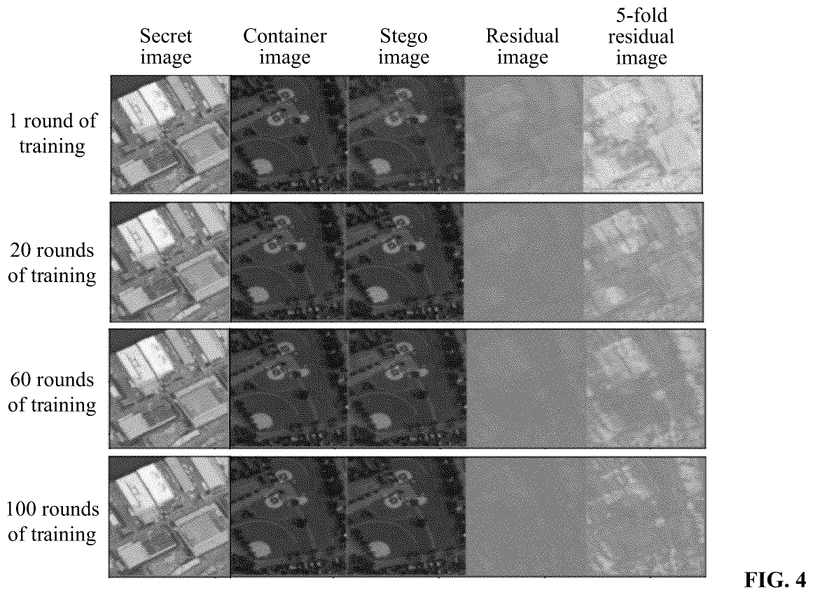

### DETAILED DESCRIPTIONS OF EMBODIMENTS

The technical solution of the embodiments of the disclosure will be fully and clearly described in combination with the embodiments of the disclosure. Apparently, the embodiments described herein are merely some embodiments of the disclosure rather than all embodiments. All other embodiments obtained by those skilled in the art based on these embodiments without making creative work shall fall within the scope of protection of the disclosure.

It is to be noted that in case of no conflicts, the embodiments and the features of the embodiments of the disclosure can be mutually combined.

The disclosure will be further described in combination with specific embodiments and but shall not be used to limit the disclosure.

In this embodiment, it is intended to address the following problems: in the existing decoding and encoding network steganography, relevant information of the secret image can be obtained by computing the residual image of the secret image and the container image; the reconstructed secret image will have a lower similarity with the original secret image due to influence of the information of the container image; and, the loss function only considers the pixel values, leading to difference between the stego image and the container image in brightness, contrast and resolution. In this embodiment, improvements are made in structural similarity index and peak signal-to-noise ratio index, and a rough contour of the secret image will be no longer displayed on the residual image, thereby improving the imperceptibility and robustness of the stego image.

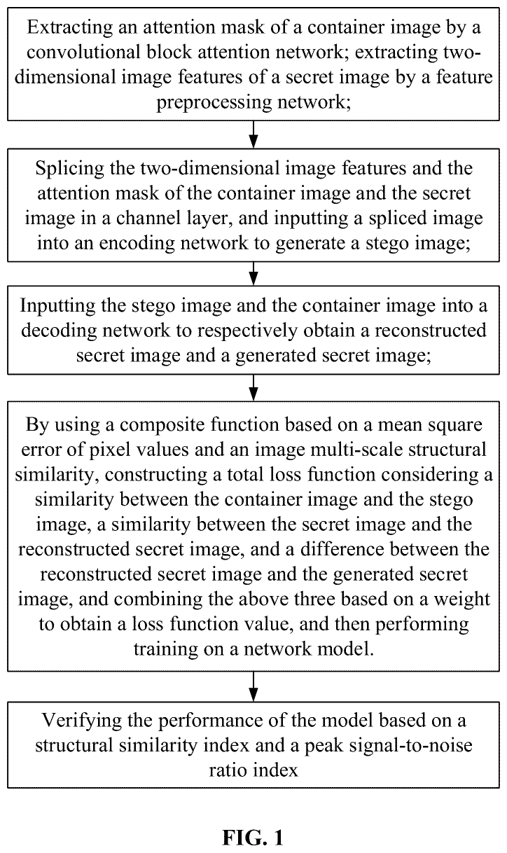

This embodiment is achieved by the following technical solution. As shown in FIG. 1, there is provided a method for decoding and encoding network steganography utilizing an enhanced attention mechanism and loss function. By this method, one color image can be invisibly hidden into a color image of same size. The method includes the following steps.
1) An attention mask of a container image is extracted by a convolutional block attention network; two-dimensional image features of a secret image are extracted by a feature preprocessing network.
2) The two-dimensional image features and the attention mask of the container image and the secret image are spliced in a channel layer, and a spliced image is input into an encoding network to generate a stego image.
3) The stego image and the container image are input into a decoding network to respectively obtain a reconstructed secret image and a generated secret image.
4) by using a composite function based on a mean square error of pixel values and an image multi-scale structural similarity, a total loss function considering a similarity between the container image and the stego image, a similarity between the secret image and the reconstructed secret image, and a difference between the reconstructed secret image and the generated secret image is constructed, and thus training is performed on a network model.
5) The performance of the model is verified based on a structural similarity index and a peak signal-to-noise ratio index.

Furthermore, the convolutional block attention network has the following mechanism: the convolutional block attention network uses ResNet50 as a benchmark architecture including two independent sub-modules, i.e. a channel attention module and a spatial attention module, to respectively perform attention mask extraction in channel and space, where the sub-modules are combined in a sequence of channel before space. The container image is input into the convolutional block attention network to generate the attention mask such that the encoding network reasonably selects a range and a position of embedding a secret into the container image.

Furthermore, the entire network training target is as follows:
a) For the convolutional block attention network and the feature preprocessing network, their parameters can be updated along with model training, and a region of the container image into which the secret image can be embedded and a feature combination of the secret image suitable to be embedded into the container image can be learned respectively.
b) The encoding network makes the stego image and the container image similar to each other as possible, and the decoding network makes the reconstructed secret image and the secret image similar to each other and the reconstructed secret image and the generated secret image irrelevant as possible.

Furthermore, the composite function in step 4) is expressed as follows:

L^{Mix}(x−x′)=α·L^{MS-SSIM}(x−x′)+(1−α)·G_{σ}_{_{G}}_{^{M}}·L^{l}^{₂}(x−x′)

where L^{MS-SSIM} represents a multi-scale structural similarity loss function, which considers brightness, contrast, structure and resolution, and is very sensitive to partial structural change and retains high-frequency details; L^{l}^{₂} represents a mean square error loss function to compute a Euclidean distance between a true value and a prediction value pixel by pixel, α refers to a balance parameter for a proportion of multi-scale structural similarity loss and a mean square error loss in the composite function; and G_{σ}_{_{G}}_{^{M}} refers to a Gaussian distribution parameter.

Furthermore, the total loss function in step 4) can be expressed as follows:

$${L}_{total} = {λ}_{c} {L}^{M i x} ( C - {C}^{′} ) + {λ}_{s} {L}^{M i x} ( S - {S}^{′} ) + {λ}_{r} \frac{1}{{L}^{M i x} ( {S}^{′} - G )}$$

where Lₜₒₜₐₗ represents a steganography loss function, L^{Mix}(C−C′) represents an error item of the container image C and the stego image C′; L^{Mix}(S−S′) represents an error term of the secret image S and the reconstructed secret image S′; L^{Mix}(S′−G) represents an error of the reconstructed secret image S′ and the generated secret image G, and λc, λs, λr respectively represent balance parameters for proportions of the error item of the container image and the stego image, the error term of the secret image and the reconstructed secret image, and the error of the reconstructed secret image and the generated secret image in the steganography loss function.

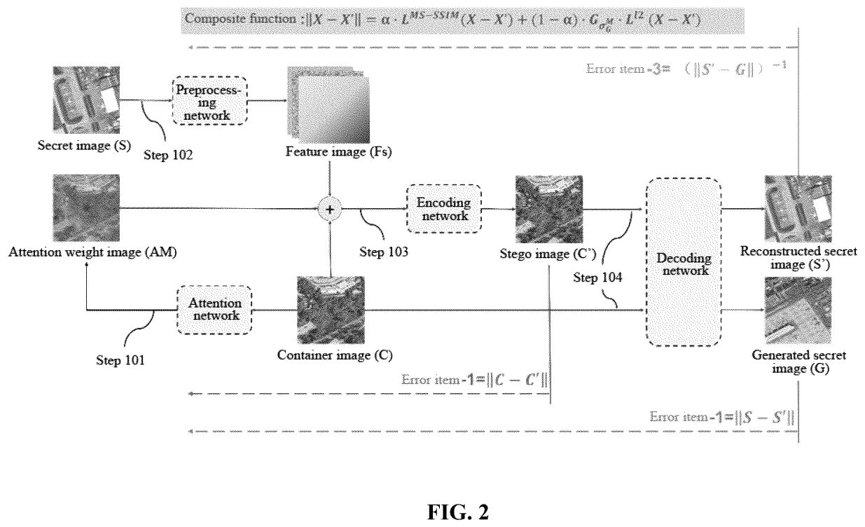

In a specific implementation, the method for decoding and encoding network steganography utilizing an enhanced attention mechanism and loss function is applicable to embedding a color secret image into a color container image. In this steganography method, the model is trained by using data sets to obtain optimal model parameters. The network forward computation flow as shown in FIG. 2 mainly includes the following steps.

At step 101, the container image C is input into the convolutional block attention network CBMA(·) to obtain an attention mask AM which is represented as follows:

AM=CBMA(C)

In information theory, a natural image has three types of regions: texture, edge and smooth region, where the texture and the edge represent a high-frequency part of the image, and the smooth region represents a low-frequency part of the image. In order to ensure the security of the stego image, the pixels of the secret image shall not be embedded into the smooth region but into the complex edge and texture. Hence, the attention mechanism is introduced to help the encoding and decoding networks to definitely learn the feature and help extract the structural features of the container image. Enhancing intra-network information flow by stressing and suppressing image information helps the model to perceive an attention center and an inconspicuous region of the container image. In this embodiment, the convolutional block attention network CBMA(·) is used to achieve the attention mechanism. The convolutional block attention network uses ResNet50 as a benchmark architecture including two independent sub-modules, with specific steps below:

C′=Mc(C)⊗C

AM=Ms(C′)⊗C′
where Mc refers to a channel attention module, and Ms refers to a space attention module, where the attention mask AM of the container image is extracted in a sequence of channel before space, and ⊗^{⊗} refers to a multiplication operation of pixel level.

At step 102, the secret image is input into the feature preprocessing network PrepNet(·) to obtain its two-dimensional image features Fs which is expressed as follows:

Fs=PrepNet(S)

At step 103, the two-dimensional image features Fs and the attention mask AM of the container image C and the secret image are spliced in a channel layer, and a spliced image is input into an encoding network EncoderNet(·) to generate a stego image C′, which is expressed as follows:

C′=EncoderNet(C+Fs+AM)

At step 104, the stego imageC′ and the container image C are input into a decoding network to respectively obtain a reconstructed secret image S′ and a generated secret image G, which are expressed as follows:

S′=DecoderNet(C′)

G=DecoderNet(C)

In this embodiment, entire training is performed on a network formed of the above four sub-networks in the following steps.

At step 201, by using a composite function based on a mean square error of pixel values and an image multi-scale structural similarity, a total loss function considering a similarity between the container image and the stego image, a similarity between the secret image and the reconstructed secret image, and a difference between the reconstructed secret image and the generated secret image is constructed. The above three are combined based on a weight to obtain a loss function value, and then training is performed on a network model. The calculation formula of the composite function is:

L^{Mix}(x−x′)=α·L^{MS-SSIM}(x−x′)+(1−α)·G_{σ}_{_{G}}_{^{M}}·L^{l}^{₂}(x−x′)

where, L^{MS-SSIM} represents a multi-scale structural similarity loss function, which considers brightness, contrast, structure and resolution, and is very sensitive to partial structural change and retains high-frequency details; L^{l}^{₂} represents a mean square error loss function to compute a Euclidean distance between a true value and a prediction value pixel by pixel, α refers to a balance parameter for a proportion of multi-scale structural similarity loss and a mean square error loss in the composite function; and G_{σ}_{_{G}}_{^{M}} refers to a Gaussian distribution parameter. Further, the total loss function is expressed as follows:

$${L}_{total} = {λ}_{c} {L}^{M i x} ( C - {C}^{′} ) + {λ}_{s} {L}^{M i x} ( S - {S}^{′} ) + {λ}_{r} \frac{1}{{L}^{M i x} ( {S}^{′} - G )}$$

where, Lₜₒₜₐₗ represents a steganography loss function, L^{Mix}(C−C′) represents an error item of the container image C and the stego image C′; L^{Mix}(S−S′) represents an error term of the secret image S and the reconstructed secret image S′; L^{Mix} (S′−G) represents an error of the reconstructed secret image S′ and the generated secret image G, and λc, λs, λr respectively represent balance parameters for proportions of the error item of the container image and the stego image, the error term of the secret image and the reconstructed secret image, and the error of the reconstructed secret image and the generated secret image in the steganography loss function. It should be noted that, the error item of the container image C and the stego image C′ is not involved in updating the parameters of the decoding network in a training process.

At step 202, based on the structural similarity index and the peak signal-to-noise ratio index, the similarity between the stego image and the container image and the similarity between the secret image and the reconstructed secret image can be calculated to verify the performance of the model.

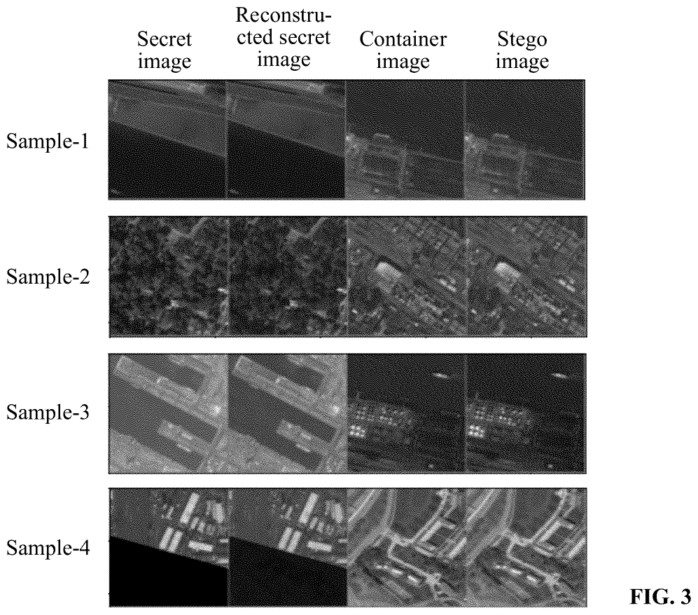

In this embodiment, under the framework of the decoding and encoding networks, the calculation of the loss function and its loss value is improved, and considerations are made for the followings: the information of the reconstructed secret image shall not be affected by the information of the carrier image, the image similarity is considered, and the entire brightness, contrast and resolution are to be made similar as possible while the difference value of the pixel-wise point is small. As shown in FIG. 3, it is a schematic diagram illustrating a sample result of performing image steganography in FAIR1M training set in this embodiment. It can be seen that there is an extremely high similarity between the stego image and the original carrier image, and between the reconstructed secret image and the original secret image.

In this embodiment, under the framework of the encoding and decoding network, the convolutional attention module is introduced to obtain a space and channel mask of the container image, and mark some regions not suitable for hiding the secret data on the images based on an attention weight, such that it is not involved in calculation, statistics and update of parameters. By observing the residual image 3 of the stego image and the container image after test in this embodiment, it can be clearly seen that, after stepwise training with the steganography in this embodiment, the secret information is initially uniformly distributed and later distributed with different weights in the container image and mainly distributed in the region of complex texture. The residual value of the stego image and the container image cannot display the rough contour of the secret image, so as to improve the security of the stego image.

It will be obvious to those skilled in the art that changes and modifications may be made, and therefore, the aim in the appended claims is to cover all such changes and modifications.

What is claimed is:

1. A method for decoding and encoding network steganography utilizing an enhanced attention mechanism and loss function, the method comprising:
S1, extracting an attention mask of a container image by a convolutional block attention network; extracting two-dimensional image features of a secret image by a feature preprocessing network;
S2, splicing the two-dimensional image features and the attention mask of the container image and the secret image in a channel layer, and inputting a spliced image into an encoding network to generate a stego image;
S3, inputting the stego image and the container image into a decoding network to respectively obtain a reconstructed secret image and a generated secret image; and
S4, by using a composite function based on a mean square error of pixel values and an image multi-scale structural similarity, constructing a total loss function considering a similarity between the container image and the stego image, a similarity between the secret image and the reconstructed secret image, and a difference between the reconstructed secret image and the generated secret image, and thus performing training on a network model.

2. The method of claim 1, wherein the implementation of S1 comprises the following steps:
S1.1, inputting the container image into the convolutional block attention network to generate the attention mask such that the encoding network reasonably selects a range and a position of embedding a secret into the container image; and
S1.2, inputting the secret image into the feature preprocessing network to obtain the two-dimensional image features of the secret image.

3. The method of claim 2, wherein the convolutional block attention network uses ResNet50 as a benchmark architecture comprising a channel attention module and a spatial attention module to respectively perform attention mask extraction in channel and space, and the channel attention module and the spatial attention module are combined in a sequence of channel before space.

4. The method of claim 1, wherein the implementation of S3 comprises the following steps:
S3.1, inputting the stego image generated in S2 into the decoding network to obtain the reconstructed secret image and determining a similarity between the reconstructed secret image and an original secret image; and
S3.2, inputting the container image to the decoding network to obtain the generated secret image and computing a difference between the generated secret image and the reconstructed secret image.

5. The method of claim 1, wherein the implementation of S4 comprises the following steps:
S4.1, computing the composite function based on the mean square error of pixel values and the image multi-scale structural similarity:
L^{Mix}(x−x′)=α·L^{MS-SSIM}(x−x′)+(1−α)·G_{σ}_{_{G}}_{^{M}}·L^{l}^{₂}(x−x′)
wherein, L^{MS-SSIM} represents a multi-scale structural similarity loss function, which considers brightness, contrast, structure and resolution, and is sensitive to partial structural change and retains high-frequency details; L^{l}^{₂} represents a mean square error loss function to compute a Euclidean distance between a true value and a prediction value pixel by pixel, α refers to a balance parameter for a proportion of multi-scale structural similarity loss and a mean square error loss in the composite function; and G_{σ}_{_{G}}_{^{M}} refers to a Gaussian distribution parameter; and
S4.2, constructing the total loss function considering the similarity between the container image and the stego image, the similarity between the secret image and the reconstructed secret image, and a difference between the reconstructed secret image and the generated secret image:
$${L}_{total} = {λ}_{c} {L}^{M i x} ( C - {C}^{′} ) + {λ}_{s} {L}^{M i x} ( S - {S}^{′} ) + {λ}_{r} \frac{1}{{L}^{M i x} ( {S}^{′} - G )} ;$$
wherein, Lₜₒₜₐₗ represents a steganography loss function, L^{Mix}(C−C′) represents an error item of the container image C and the stego image C′; L^{Mix} (S−S′) represents an error term of the secret image S and the reconstructed secret image S′; L^{Mix} (S′−G) represents an error of the reconstructed secret image S′ and the generated secret image G, and λc, λs, λr respectively represent balance parameters for proportions of the error item of the container image and the stego image, the error term of the secret image and the reconstructed secret image, and the error of the reconstructed secret image and the generated secret image in the steganography loss function.
